(19) United States
(12) Patent Application Publication
(10) Pub. No.: US 2013/0198087 A1
(43) Pub. Date: Aug. 1, 2013

(54) METHOD AND APPARATUS FOR PROVIDING SUPPORT FOR INTERNET-BASED SERVICES

(71) Applicants: MICHAEL BEATTIE, Stanhope, NJ (US); MURALI RAMSUNDER, Springfield, NJ (US)

(72) Inventors: MICHAEL BEATTIE, Stanhope, NJ (US); MURALI RAMSUNDER, Springfield, NJ (US)

(73) Assignee: VONAGE NETWORK LLC, Holmdel, NJ (US)

(21) Appl. No.: 13/362,592

(22) Filed: Jan. 31, 2012

(51) Int. Cl. G06Q 99/00

(52) U.S. Cl. 705/304

(57) ABSTRACT

A method and apparatus for providing support for an Internet-based service. One embodiment of the method comprises gathering user information related to one or more of user identification, user hardware, user software, or browsing session information, and displaying agent contact information and a PIN, the PIN associated with the user information to enable an agent to access the user information to support a user's interaction with the agent. The apparatus comprises a user computer for executing an applet for gathering user information related to one or more of user identification, user hardware, user software, or browsing session information. A web server for coupling agent contact information and a PIN to the user computer, the PIN associated with the user information to enable an agent to access the user information to support a user's interaction with the agent. The user computer displays the agent contact information and the PIN.

### BACKGROUND OF THE INVENTION

1. Field of the Invention

Embodiments of the present invention generally relate to an Internet based services and, more particularly, a method and apparatus for providing support for Internet-based services.

2. Description of the Related Art

While accessing Internet-based services, a user may require support to accomplish a specific task. For example, a user may have trouble logging in to a specific website, have questions about a specific product have trouble utilizing a specific online service, and the like. In some instances, a helpline telephone number or chat link is provided to the user on one or more of the webpages being browsed. To receive help, a user may initialize a chat session or call an agent via telephone.

Once connected, the agent generally asks the user a series of background questions to gather information regarding, for example, the user's current session, hardware being used, software being used, user identification information, and other “boilerplate” background information. If the user must re-connect with an agent at a later time, in many instances, the agent must request this background information again. Although such information is necessary for providing assistance to a user, gathering such information is time-consuming for both the user and the agent. Streamlining this initial process benefits both the user and the agent.

Therefore, there is a need in the art for a method and apparatus to provide improved support for Internet-based services.

### SUMMARY OF THE INVENTION

Embodiments of the present invention generally comprise a method and apparatus for providing support for an Internet-based service. One embodiment of the method comprises gathering user information related to one or more of user identification, user hardware, user software, or browsing session information, and displaying agent contact information and a personal identification number (PIN), where the PIN is associated with the user information to enable an agent to access the user information to support a user's interaction with the agent.

Another embodiment of the invention comprises apparatus for providing support for an Internet-based service. The apparatus comprises a user computer for executing an applet for gathering user information related to one or more of user identification, user hardware, user software, or browsing session information. A web server for coupling agent contact information and a personal identification number (PIN) to the user computer, where the PIN is associated with the user information to enable an agent to access the user information to support a user's interaction with the agent. The user computer displays the agent contact information and the PIN.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a system for providing support for Internet-based services in accordance with at least one embodiment of the present invention;

FIG. 2 depicts a representation of a screen display that facilitates support for Internet-based services in accordance with the least one embodiment of the present invention;

FIG. 3 depicts a flow diagram of a method of operation and interaction between a user computer and a Web server in accordance with at least one embodiment of the present invention; and

FIG. 4 depicts a flow diagram of a method of interaction between a user and an agent in accordance with at least one embodiment of the present invention.

While the method and apparatus for providing support for an Internet-based service is described herein by way of example for several embodiments and illustrative drawings, those skilled in the art will recognize that method and apparatus for providing support for an Internet-based service is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of method and apparatus for providing support for an Internet-based service as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention include a method and apparatus for providing support for Internet-based services. In one embodiment, a user computer interacts with a web server to receive and display various webpages. As the webpages are browsed, a user data applet gathers and stores user information regarding the user and/or the present browsing session. The user information may be stored locally on the user computer and/or periodically transferred to the web server (or another computer that is accessible to a support agent). The webpages being browsed may contain information (e.g., text, buttons, links and/or the like) to enable a user to request assistance from an agent. The information comprises agent contact information (e.g., a helpline telephone number, a link to a chat session, email address, and/or the like) and a personal identification number (PIN). When the user contacts the agent and provides the PIN to the agent, the agent can access the user information using the PIN. User information is displayed to the agent to facilitate solving the users problem. By displaying the user information in this manner, the agent and the user avoid the need to gather boilerplate, background information regarding the user and/or the user's current session. As such, the agent can quickly focus on and resolve the user's issue.

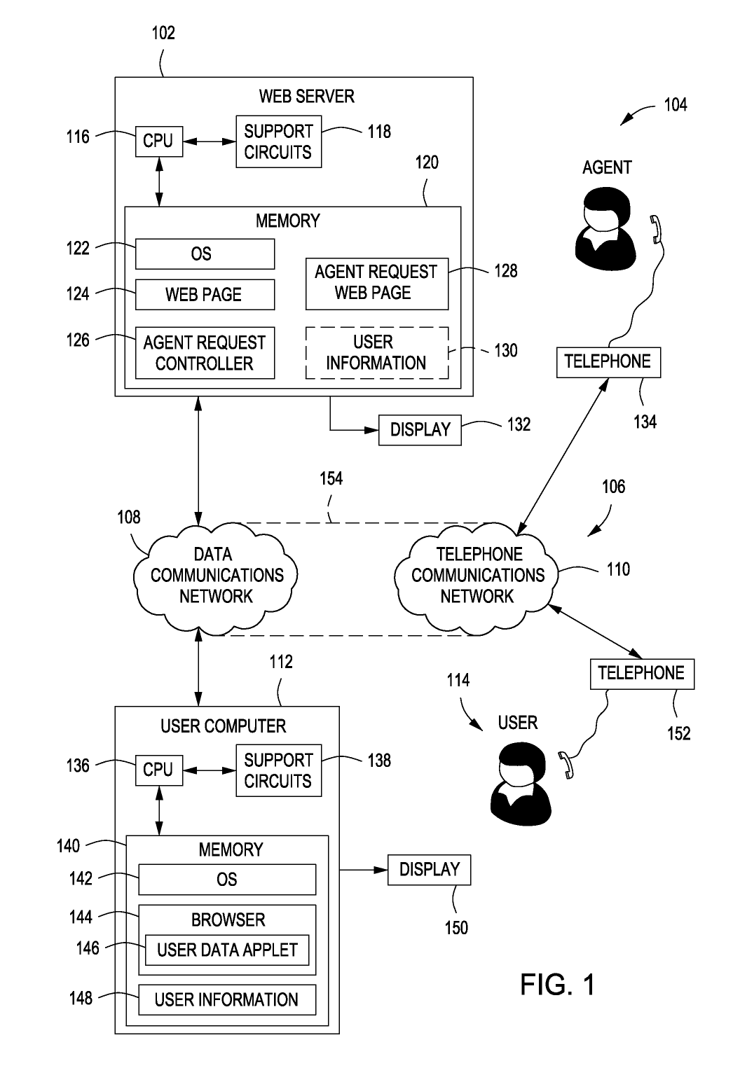

FIG. 1 depicts an Internet-based system 100 for providing support for Internet-based services in accordance with at least one embodiment of the invention. The system 100 comprises a web server 102 coupled to a user computer 112 via a data communications network 108. In one embodiment, the user 114 may communicate with an agent 104 via a telephone communications network 110. In some embodiments, the data communications network 108 and the telecommunications network 110 are the same network 106 (as indicated by dashed lines 154).

The web server 102 comprises a central processing unit (CPU) 116, support circuits 118 and memory 120. The CPU 116 may be one or more commercially available processors, controllers, microprocessors, microcontrollers, and the like. The support circuits 118 facilitate functionality of the CPU 116. The support circuits 118 comprise, for example, but are not limited to, clock circuits, network interface circuits, power supplies, cache, and the like. The memory 120 may be any type of storage used for storing digital information and applications. Such memory includes, but is not limited to, random access memory, read-only memory, magnetic or optical disk storage, and the like.

The memory 120 stores an operating system (OS) 122, at least one webpage 124, an agent request webpage 128, an agent request controller 126, and user information 130. The operating system 122 comprises a well-known operating system for providing functionality to the web server 102. Such operating systems include Linux, UNIX, Apple OS, Windows, and the like. The webpage 124 and the agent request webpage 128 are selectively served for display on a user computer as described below. The agent request controller 126 comprises software that is executed upon the user requesting agent support. In one embodiment, user information 130 comprises user identification as well as user web browsing session information when interacting with the at least one webpage 124. A display 132 is coupled to the web server 102 to display the user information 132 to an agent as needed.

Data communications network 108 comprises well-known switching circuits to facilitate coupling webpages and webpage requests between the web server 102 and the user computer 112.

The user computer 112 comprises a central processing unit (CPU) 136, support circuits 138 and memory 140. The CPU 136 may be one or more commercially available processors, controllers, microprocessors, microcontrollers, and the like. The support circuits 138 facilitate functionality of the CPU 136. The support circuits 138 comprise, for example, but are not limited to, clock circuits, network interface circuits, power supplies, cache, and the like. The memory 140 may be any type of storage used for storing digital information and applications. Such memory includes, but is not limited to, random access memory, read-only memory, magnetic or optical disk storage, and the like.

The memory 140 stores an operating system (OS) 142, a browser 144, and user information 148. The operating system 142 comprises a well-known operating system for providing functionality to the user computer 112. Such operating systems include Linux, UNIX, Apple OS, Windows, and the like.

The browser 144 facilitates requesting and display of the at least one webpage 124 upon the display 150. The browser 144 comprises a user data applet 146 (e.g., a plug-in or extension) that gathers user information upon the user accessing the at least one webpage 124. The applet 146 may simply access existing session logs to create the user information 130, or the applet may actively collect session information while a user is browsing a particular set of webpages (e.g., a particular web site at a particular Internet domain). In one embodiment, user information 130 comprises at least one of user identification, user hardware, user software, or browsing session information. The browsing session information is collected while interacting with the at least one webpage 124. A display 132 is coupled to the user computer 112 to display webpage 124 to a user 114.

In operation, the user 114 manipulates inputs to the browser 144 to request at least one webpage 124 to be displayed on display 150. In one embodiment, while interacting with the at least one webpage 124, the user data applet 146 collects user information 148 with regard to the users session. In other embodiments, the browser captures user session information. The user information 148 may be stored in a computer that is accessible to the agent 104, e.g., in a database (information 148) within the user computer 112, within a database (information 130) within the web server 102, or within another computer (not shown) that is accessible to the agent 104. The at least one webpage 124 may comprise a button or link to facilitate requesting agent assistance. In other embodiments, agent communication initialization information may appear automatically upon detection of an error in communicating the webpage 124 or entering data.

Upon requesting agent support (either by error detection or user selection), the agent request controller 126 sends agent communication initialization information (e.g., an agent request webpage 128) to the user computer 112 for display. The agent request webpage 128 may be a full-page, partial-page, a pop-up, a banner or some other form of communicative display. The communication initialization information comprises, for example, a helpline telephone number (or chat session link) and a personal identification number (PIN). In some embodiments, the PIN may be a code (numerical or alpha-numeric, a bar code, a QR code, or some other identifier that links the user and the user data. The PIN is used to uniquely identify the user information related to the user holding the PIN. Typically, a PIN will expire at the end of a session, but could have a longer existence depending on the situation, e.g., is there an expectation that a user will need agent assistance after a browsing session is complete. The user 114 then utilizes the telephone 152 to call the agent 104 via telephone 134. In other embodiments, as described below, the user may contact the agent via email, chat, or any other form of communication. The user 114 supplies the agent 104 with the PIN. The agent 104 uses the PIN to access the user information 130 such that the agent quickly obtains the user's identification and/or information regarding the current web session. The agent 104 can then focus on the user's issue and not focus on collecting background information.

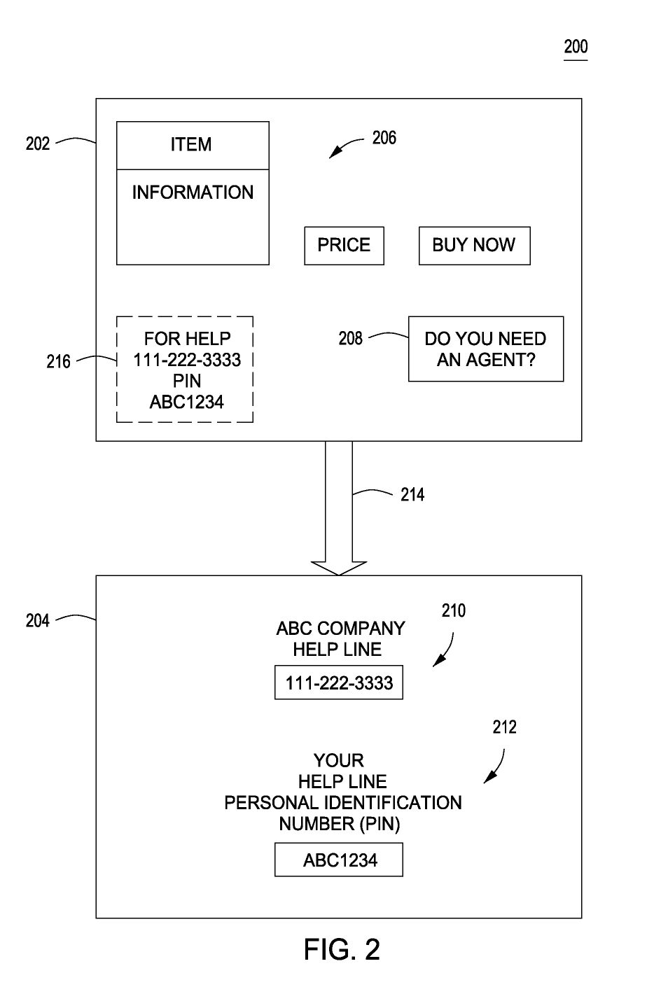

FIG. 2 depicts one embodiment of a representation of a screen display 200 that facilitates support for Internet-based services in accordance with the least one embodiment of the present invention. A first screen display 202 depicts a webpage 206 containing shopping information regarding a product item. Included in the webpage 206 is a button 208 (e.g., DO YOU NEED AN AGENT? button) that can be selected by a user when an agent is needed to assist with an issue.

Upon selecting the button 208, display 202 changes as indicated by arrow 214 to appear as display 204. Display 204 may appear as a pop-up, overlay, banner, full-page, partial page, and the like. Any form of display may be used to communicate to the user the agent communication initialization information (e.g., a helpline telephone number 210 and a personal identification number 212). In other embodiments, the display 204 may be presented to a user upon an error being detected in the webpage, the communications between the user computer and the web server, and the data entered by a user (e.g., login error, data entry error, and the like), or any other situation where the assistance of an agent may be required.

In another embodiment, as represented by dashed area 216, the help line contact information (e.g., phone number, email address, chat link, and the like) and the PIN are displayed on each webpage 202. The PIN is uniquely generated and inserted onto the page for use by the particular user. A single PIN may be generated for the user's current browsing session, or a PIN may be created for each new page the user visits. Upon contacting the agent for help, the user provides the PIN and the agent accesses the browsing session records for the user's current session. In this manner, the additional communicative banner or page 204 is not required.

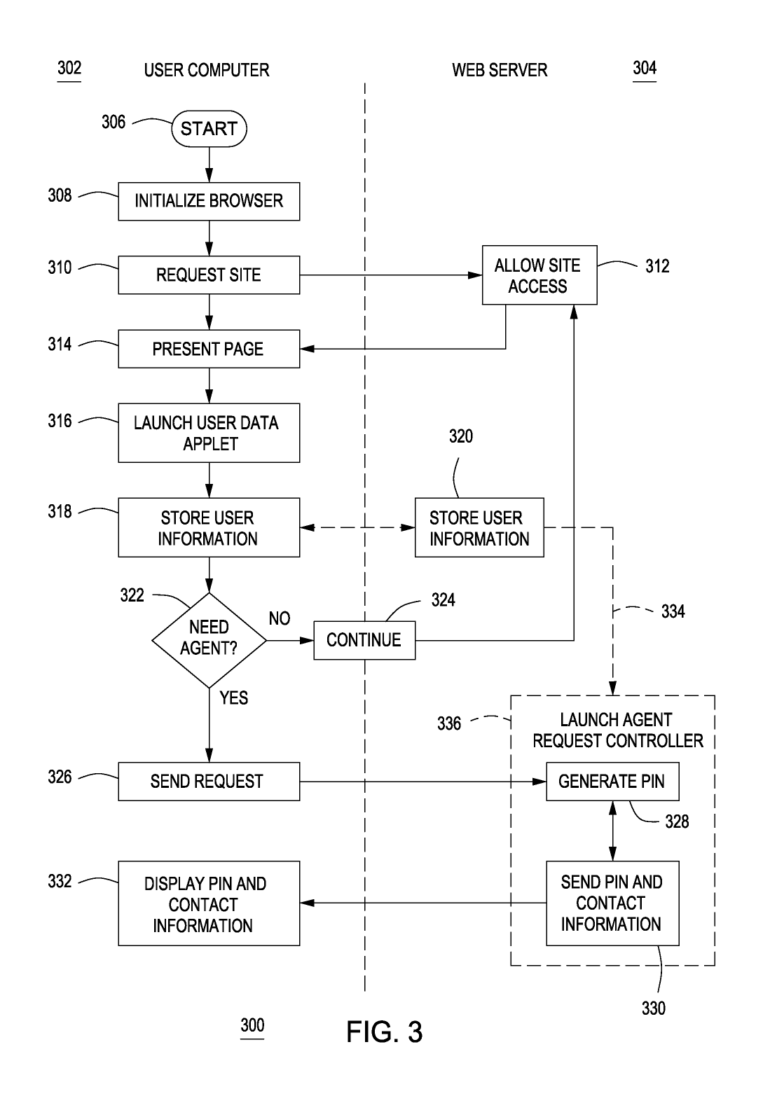

FIG. 3 depicts a flow diagram of a method 300 of operation and interaction between a user computer and a web server in accordance with at least one embodiment of the present invention. The method 300 is divided into method 302 representing steps performed by the user computer and method 304 representing steps performed by the web server. The method 300 begins at step 306 and proceeds to step 308, where the browser is initialized to run on the user computer. At step 310, the browser requests a webpage from a website available from the web server. The request is communicated to the web server and, at step 312, the web server allows access to the site and makes the requested webpage available to the user computer. At step 314, the user computer presents the webpage to the user.

In response to the utilization of the website that is implemented in accordance with embodiments of the present invention, at step 316, the user data applet is launched to collect user information, for example, user identity, hardware type, software type, web browsing session information, and/or the like. Generally speaking, the user information is, for example, information that would otherwise be collected by an agent as background information when a user contacts the agent. At step 318, the method 300 stores the user information. The storage may occur locally, within the user computer, and/or remotely, within the web server (or another computer that is accessible to the agent), as represented by step 320. In one embodiment, the user information is stored in a database on a computer that is accessible to an agent, e.g., the web server. The user information is related to a “key” (i.e., the PIN) that uniquely associates the user and the user information. The PIN may be created upon the user requesting assistance (as described below) or it may be automatically created at the time the user information is stored (as represented by path 334).

At step 322, the method 300 queries whether the user requires an agent. Typically, this query is passive, awaiting an indication from the user that an agent is needed by selecting a button or link to implement the request. In other instances, the query may be activated in response to an error detected in any communications or data entry. In either instance, if the query at 322 is negatively answered (no agent needed), the method 300 continues along the path 324 to provide further site access and allow further web browsing. If the query in step 322 is affirmatively answered (agent needed), the method 300 proceeds to step 326. At step 326, a request is transmitted to the web server 102 to launch the agent request controller at step 336.

The agent request controller generates a PIN at step 328 and sends the PIN and the agent contact information (e.g., helpline telephone number, chat session link, email address, and/or the like) to the user computer at step 330. At step 332, the method 300 displays the PIN and agent contact information on the display at the user computer. As such, the user is now prepared to efficiently interact with the agent without a need to supply background information or session information to the agent.

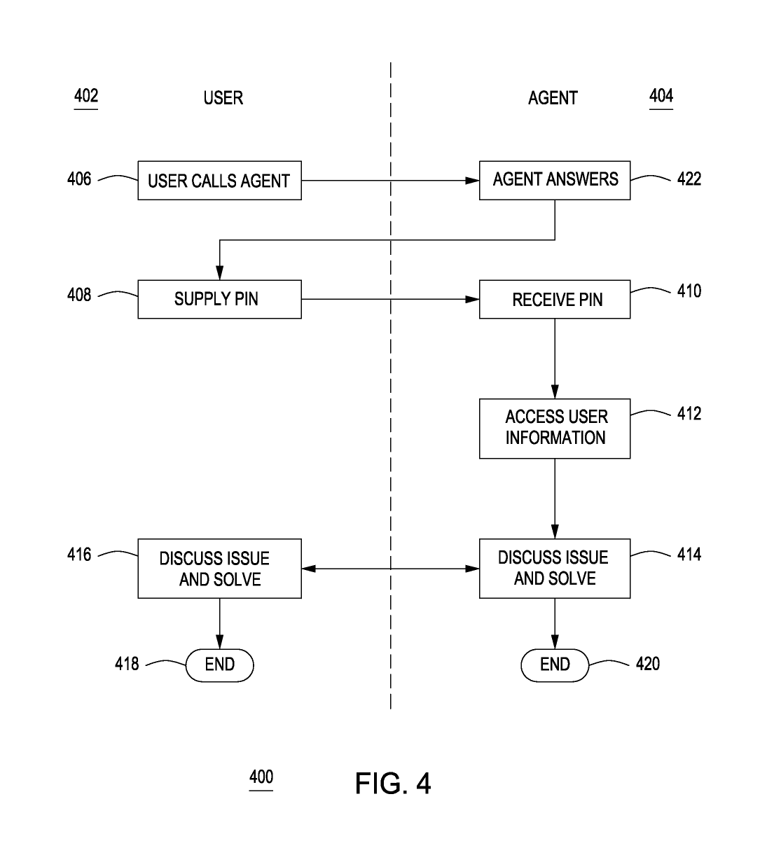

FIG. 4 depicts a flow diagram of a method 400 representing interaction between a user and an agent in accordance with at least one embodiment of the present invention. The method 400 is divided into method 402 representing steps performed by a user and method 404 representing steps performed by an agent. The method 400 begins at step 406 where the user calls an agent using the helpline telephone number displayed on the screen at step 332 of FIG. 3. At step 422, the agent answers the call and request that a PIN be provided. At step 408, the user supplies the PIN to the agent and the agent receives the PIN at step 410. In embodiments where a chat session is launched to support the user, the PIN is provided through the chat interface.

At step 412, the agent accesses the user information identified in association with the user supplied PIN. The user information, for example, including user identity, user hardware, user software, browser session information, and/or the like. At steps 414 and 416, the user an agent immediately discuss the users issue and find a solution without the need for the user to provide background information regarding the session or the user's identity. Once a solution is found, the user and agent end the call in steps 418 and 420.

In the foregoing embodiment, the user and agent resolve the user's issue by using a telephone communication. In other embodiments, the user may utilize another form of communication such as a chat session and supply the PIN via the chat interface. Additionally, the communication (call or chat) may be instantiated by a button on the webpage such that a chat session or a voice over IP call through the Internet is instantly begun.

In another embodiment, a PIN may be uniquely generated for each webpage that is being browsed by the user. To initialize a communication with an agent, the user may merely click on the display of the PIN. Such a selection sends the PIN to the web server to allow the agent request controller to automatically assign an agent that is best suited for handling issues that may arise on that particular webpage. In other embodiments, the PIN may be associated with webpages that have a historically high incidence of resulting in agent assistance.

While the foregoing is directed to embodiments of the present invention, other and further embodiments of the invention may be devised without departing from the basic scope thereof, and the scope thereof is determined by the claims that follow.

1. A computer-implemented method of providing support for an Internet-based service comprising:
gathering user information related to one or more of user identification, user hardware, user software, or browsing session information; and
displaying agent contact information and a personal identification number (PIN), where the PIN is associated with the user information to enable an agent to access the user information to support a user's interaction with the agent.

2. The method of claim 1 wherein gathering comprises launching an applet.

3. The method of claim 2 wherein the applet gathers and stores the user information.

4. The method of claim 3 wherein the applet stores the user information on a user computer.

5. The method of claim 3 wherein the applet sends the user information to a computer that is accessible to the agent.

6. The method of claim 1 wherein displaying comprises displaying within a banner, pop-up, full webpage, or partial webpage.

7. The method of claim 1 wherein displaying occurs in response to the user requesting agent assistance.

8. The method of claim 1 wherein displaying occurs in response to detection of an error in at least one of communications or data entry.

9. The method of claim 1 wherein displaying occurs on a webpage which user's historically experience difficulty.

10. The method of claim 1 wherein the agent contact information is at least one of a telephone number, an email address or a link to a chat session.

11. Apparatus for providing support for an Internet-based service comprising:
a user computer for executing an applet for gathering user information related to one or more of user identification, user hardware, user software, or browsing session information;
a web server for coupling agent contact information and a personal identification number (PIN) to the user computer, where the PIN is associated with the user information to enable an agent to access the user information to support a user's interaction with the agent; and
the user computer displays the agent contact information and the PIN.

12. The apparatus of claim 11 wherein the applet gathers and stores the user information.

13. The method of claim 11 wherein the applet stores the user information on the user computer.

14. The apparatus of claim 13 wherein the applet sends the user information to a computer that is accessible to the agent.

15. The apparatus of claim 11 wherein a display a banner, pop-up, full webpage, or partial webpage.

16. The apparatus of claim 11 wherein the display occurs in response to the user requesting agent assistance.

17. The apparatus of claim 11 wherein the display occurs in response to detection of an error in at least one of communications or data entry.

18. The apparatus of claim 11 wherein the display occurs on a webpage which user's historically experience difficulty.

19. The apparatus of claim 11 wherein the agent communication initialization information is at least one of a telephone number or a link to a chat session.
